(19) United States
(12) Patent Application Publication
(10) Pub. No.: US 2026/0371213 A1
(43) Pub. Date: Nov. 19, 2026

(54) RESOURCE RELEASE ENHANCEMENT IN NETWORK CONDITIONAL HANDOVER

(71) Applicant: Nokia Technologies Oy, Espoo (FI)

(72) Inventors: Ayaz AHMED, Bengaluru (IN); Ahmad AWADA, Munich (DE); Jedrzej STANCZAK, Wroclaw (PL)

(73) Assignee: Nokia Technologies Oy, Espoo (FI)

(21) Appl. No.: 19/144,056

(22) PCT Filed: Dec. 12, 2023
(86) PCT No.: PCT/EP2023/085446

§ 371 Date: Jun. 27, 2025

(30) Foreign Application Priority Data
Jan. 13, 2023 (IN) 202341002727

(51) Int. Cl. H04W 36/36; H04W 36/00

(52) U.S. Cl. CPC H04W 36/362; H04W 36/0058

(57) ABSTRACT

Systems, methods, apparatuses, and computer program products for resource release enhancement for resource release enhancement in network conditional handover (CHO). A method may include receiving, from a source cell, a reconfiguration message including a conditional handover configuration indicating whether the conditional handover configuration of a target cell should be released after a second time instance has elapsed. The method may also include evaluating a conditional handover condition. The method may further include retaining, based on the evaluation, the conditional handover configuration of the target cell associated with a time window between a first time instance and the second time instance. In addition, the method may include executing conditional handover directly to the target cell if conditional handover recovery is configured, instead of radio resource control re-establishment.

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for resource release enhancement in network conditional handover (CHO).

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving, from a source cell, a reconfiguration message including a conditional handover configuration indicating whether the conditional handover configuration of a target cell should be released after a second time instance has elapsed. The method may also include evaluating a conditional handover condition. The method may further include retaining, based on the evaluation, the conditional handover configuration of the target cell associated with a time window between a first time instance and the second time instance. In addition, the method may include executing conditional handover directly to the target cell if conditional handover recovery is configured, instead of radio resource control re-establishment.

Other example embodiments may be directed to an apparatus. The apparatus may include at least one processor and at least one memory including computer program code. The at least one memory and computer program code may also be configured to, with the at least one processor, cause the apparatus at least to receive, from a source cell, a reconfiguration message including a conditional handover configuration indicating whether the conditional handover configuration of a target cell should be released after a second time instance has elapsed. The apparatus may also be caused to evaluate a conditional handover condition. The apparatus may further be caused to retain, based on the evaluation, the conditional handover configuration of the target cell associated with a time window between a first time instance and the second time instance. In addition, the apparatus may be caused to execute conditional handover directly to the target cell if conditional handover recovery is configured, instead of radio resource control re-establishment.

Other example embodiments may be directed to an apparatus. The apparatus may include means for receiving, from a source cell, a reconfiguration message including a conditional handover configuration indicating whether the conditional handover configuration of a target cell should be released after a second time instance has elapsed. The apparatus may also include means for evaluating a conditional handover condition. The apparatus may further include means for retaining, based on the evaluation, the conditional handover configuration of the target cell associated with a time window between a first time instance and the second time instance. In addition, the apparatus may include means for executing conditional handover directly to the target cell if conditional handover recovery is configured, instead of radio resource control re-establishment.

In accordance with other example embodiments, a non-transitory computer readable medium may be encoded with instructions that may, when executed in hardware, perform a method. The method may include receiving, from a source cell, a reconfiguration message including a conditional handover configuration indicating whether the conditional handover configuration of a target cell should be released after a second time instance has elapsed. The method may also include evaluating a conditional handover condition. The method may further include retaining, based on the evaluation, the conditional handover configuration of the target cell associated with a time window between a first time instance and the second time instance. In addition, the method may include executing conditional handover directly to the target cell if conditional handover recovery is configured, instead of radio resource control re-establishment.

Other example embodiments may be directed to a computer program product that performs a method. The method may include receiving, from a source cell, a reconfiguration message including a conditional handover configuration indicating whether the conditional handover configuration of a target cell should be released after a second time instance has elapsed. The method may also include evaluating a conditional handover condition. The method may further include retaining, based on the evaluation, the conditional handover configuration of the target cell associated with a time window between a first time instance and the second time instance. In addition, the method may include executing conditional handover directly to the target cell if conditional handover recovery is configured, instead of radio resource control re-establishment.

Other example embodiments may be directed to an apparatus that may include circuitry configured to receive, from a source cell, a reconfiguration message including a conditional handover configuration indicating whether the conditional handover configuration of a target cell should be released after a second time instance has elapsed. The apparatus may also include circuitry configured to evaluate a conditional handover condition. The apparatus may further include circuitry configured to retain, based on the evaluation, the conditional handover configuration of the target cell associated with a time window between a first time instance and the second time instance. In addition, the apparatus may include circuitry configured to execute conditional handover directly to the target cell if conditional handover recovery is configured, instead of radio resource control re-establishment.

Some example embodiments may be directed to a method. The method may include sending a handover request to a target cell for handover of a user equipment to the target cell between a first time instance and a second time instance. The method may also include receiving from the target cell in response to the handover request, a handover acknowledgement message including an indication of a time period beyond the second time instance for which conditional handover resources are held by the target cell. The method may further include transmitting, to the user equipment, a reconfiguration message indicating whether a conditional handover configuration of the target cell should be released after the second time instance has expired.

Other example embodiments may be directed to an apparatus. The apparatus may include at least one processor and at least one memory including computer program code. The at least one memory and computer program code may also be configured to, with the at least one processor, cause the apparatus at least to send a handover request to a target cell for handover of a user equipment to the target cell between a first time instance and a second time instance. The apparatus may also be caused to receive from the target cell in response to the handover request, a handover acknowledgement message including an indication of a time period beyond the second time instance for which conditional handover resources are held by the target cell. The apparatus may further be caused to transmit, to the user equipment, a reconfiguration message indicating whether a conditional handover configuration of the target cell should be released after the second time instance has expired.

Other example embodiments may be directed to an apparatus. The apparatus may include means for sending a handover request to a target cell for handover of a user equipment to the target cell between a first time instance and a second time instance. The apparatus may also include means for receiving from the target cell in response to the handover request, a handover acknowledgement message including an indication of a time period beyond the second time instance for which conditional handover resources are held by the target cell. The apparatus may further include means for transmitting, to the user equipment, a reconfiguration message indicating whether a conditional handover configuration of the target cell should be released after the second time instance has expired.

In accordance with other example embodiments, a non-transitory computer readable medium may be encoded with instructions that may, when executed in hardware, perform a method. The method may include sending a handover request to a target cell for handover of a user equipment to the target cell between a first time instance and a second time instance. The method may also include receiving from the target cell in response to the handover request, a handover acknowledgement message including an indication of a time period beyond the second time instance for which conditional handover resources are held by the target cell. The method may further include transmitting, to the user equipment, a reconfiguration message indicating whether a conditional handover configuration of the target cell should be released after the second time instance has expired.

Other example embodiments may be directed to a computer program product that performs a method. The method may include sending a handover request to a target cell for handover of a user equipment to the target cell between a first time instance and a second time instance. The method may also include receiving from the target cell in response to the handover request, a handover acknowledgement message including an indication of a time period beyond the second time instance for which conditional handover resources are held by the target cell. The method may further include transmitting, to the user equipment, a reconfiguration message indicating whether a conditional handover configuration of the target cell should be released after the second time instance has expired.

Other example embodiments may be directed to an apparatus that may include circuitry configured to send a handover request to a target cell for handover of a user equipment to the target cell between a first time instance and a second time instance. The apparatus may also include circuitry configured to receive from the target cell in response to the handover request, a handover acknowledgement message including an indication of a time period beyond the second time instance for which conditional handover resources are held by the target cell. The apparatus may further include circuitry configured to transmit, to the user equipment, a reconfiguration message indicating whether a conditional handover configuration of the target cell should be released after the second time instance has expired.

Some example embodiments may be directed to a method. The method may include receiving, from a source cell, a handover request for handover of a user equipment to a target cell between a first time instance and a second time instance. The method may also include transmitting to the source cell in response to the handover request, a handover acknowledgement message comprising an indication of a time period beyond the second time instance for which conditional handover resources are held. The method may further include holding conditional handover resources for handover of the user equipment for an amount of time beyond the second time instance.

Other example embodiments may be directed to an apparatus. The apparatus may include at least one processor and at least one memory including computer program code. The at least one memory and computer program code may also be configured to, with the at least one processor, cause the apparatus at least to receive, from a source cell, a handover request for handover of a user equipment to the apparatus between a first time instance and a second time instance. The apparatus may also be caused to transmit to the source cell in response to the handover request, a handover acknowledgement message comprising an indication of a time period beyond the second time instance for which conditional handover resources are held. The apparatus may further be caused to hold conditional handover resources for handover of the user equipment for an amount of time beyond the second time instance.

Other example embodiments may be directed to an apparatus. The apparatus may include means for receiving, from a source cell, a handover request for handover of a user equipment to the apparatus between a first time instance and a second time instance. The apparatus may also include means for transmitting to the source cell in response to the handover request, a handover acknowledgement message comprising an indication of a time period beyond the second time instance for which conditional handover resources are held. The apparatus may further include means for holding conditional handover resources for handover of the user equipment for an amount of time beyond the second time instance.

In accordance with other example embodiments, a non-transitory computer readable medium may be encoded with instructions that may, when executed in hardware, perform a method. The method may include receiving, from a source cell, a handover request for handover of a user equipment to a target cell between a first time instance and a second time instance. The method may also include transmitting to the source cell in response to the handover request, a handover acknowledgement message comprising an indication of a time period beyond the second time instance for which conditional handover resources are held. The method may further include holding conditional handover resources for handover of the user equipment for an amount of time beyond the second time instance.

Other example embodiments may be directed to a computer program product that performs a method. The method may include receiving, from a source cell, a handover request for handover of a user equipment to a target cell between a first time instance and a second time instance. The method may also include transmitting to the source cell in response to the handover request, a handover acknowledgement message comprising an indication of a time period beyond the second time instance for which conditional handover resources are held. The method may further include holding conditional handover resources for handover of the user equipment for an amount of time beyond the second time instance.

Other example embodiments may be directed to an apparatus that may include circuitry configured to receive, from a source cell, a handover request for handover of a user equipment to the apparatus between a first time instance and a second time instance. The apparatus may also include circuitry configured to transmit to the source cell in response to the handover request, a handover acknowledgement message comprising an indication of a time period beyond the second time instance for which conditional handover resources are held. The apparatus may further include circuitry configured to hold conditional handover resources for handover of the user equipment for an amount of time beyond the second time instance.

### BRIEF DESCRIPTION OF THE DRAWINGS

For proper understanding of example embodiments, reference should be made to the accompanying drawings, wherein:

FIG. 1 illustrates an example of a conditional handover (CHO) with a time-window condition.

FIG. 2 illustrates an example successful CHO execution scenario in configured time window T1-T2.

FIG. 3 illustrates an example failed CHO scenario after the configured time window T1-T2.

FIG. 4 illustrates an example signal flow diagram, according to certain example embodiments.

FIG. 5 illustrates another example signal flow diagram, according to certain example embodiments.

FIG. 6 illustrates an example flow diagram of a method, according to certain example embodiments.

FIG. 7 illustrates an example flow diagram of another method, according to certain example embodiments.

FIG. 8 illustrates an example flow diagram of a further method, according to certain example embodiments.

FIG. 9 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for resource release enhancement for resource release enhancement in network CHO. For instance, certain example embodiments may be directed to enhancing resource release at a target node for time based non-terrestrial network (NTN) CHO to enable CHO recovery.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably. Additionally, the terms “target node” and “target gNB” may be used interchangeably with “target cell”. Similarly, the terms “source node” and “source gNB” may be used interchangeably with “source cell”.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of 3^{rd} Generation Partnership Project (3GPP) describes CHO as a feature enhanced for NTN by introducing new conditions to have the CHO execution not only linked to the (radio) conditions such as measurement event A3, A4, or A5 (defined in radio resource control (RRC)), but also to location condition (i.e., distance to target cell reference location, e.g., call center), or time condition (i.e., measurement event A3, A4, A5 fulfilled within the NTN specific time window between time instance 1 (t1) and time instance 2 (t2) [t1, t2]). These new conditions have been introduced as the existing received power level alone is found to be insufficient in NTN to decide whether mobility shall be triggered.

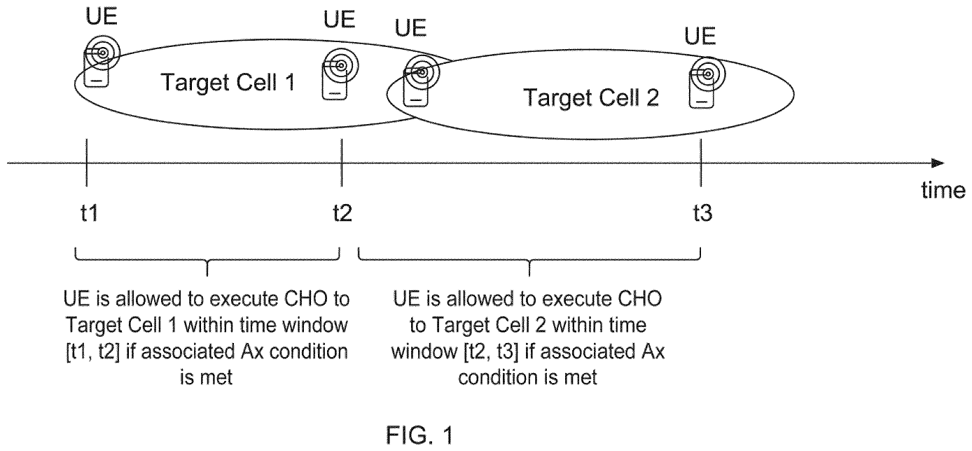

FIG. 1 illustrates an example of a CHO with a time-window condition. As illustrated in FIG. 1, the user equipment (UE) may be allowed to execute CHO to the target cell 1 within a time window [t1, t2] if the associated Ax condition is satisfied. Additionally, the UE is allowed to execute CHO to the target cell 2 within the time window [t2, t3] if the associated Ax condition is satisfied. In some cases, at the time when t2 expires, the UE may discard the CHO configuration. As per the legacy CHO recovery specified in 3GPP, when an initial CHO execution attempt fails or HO fails, the UE may perform cell selection. If the selected cell is a CHO candidate, and if the network configured the UE to try CHO after handover/CHO failure, then the UE may attempt CHO execution once; otherwise, re-establishment is performed.

Based on current 3GPP specifications, the CHO time window parameters should be signaled to the target node so that the target node can prepare resources at the appropriate time. If the UE did not connect to the prepared cell within the given window, the target node may free up resources after the time window expires. Additionally, the UE specific time window may be signaled to the target radio access network (RAN) node via Xn to assist with time-based CHO. Based on these specifications, the source node may initiate a CHO request towards the target node, and signal the UE specific time window (time “T” at which UE starts monitoring the CHO execution condition and the duration “T+X” until which the UE monitors the CHO execution condition for a given target cell) to the target node to prepare the resources for a target cell during the time window. This would suggest that if the UE does not select the candidate target cell during the configured time window, then the target cell may release the reserved resources immediately after T2=T+X, without any indication from the source cell.

In view of the current specifications, certain drawbacks may be exhibited. For instance, if the CHO execution to the target cell fails, the UE may perform CHO recovery, if configured by the network. The UE may perform cell selection, and it may happen that the selected cell corresponds to the target cell that has released its radio resources. This may occur since the cell selection criteria may be based on radio measurements, and may be enough if the UE selects a suitable cell (not necessarily the strongest one). In this example, the UE may perform RRC re-establishment, and may miss the opportunity to perform CHO recovery, especially in the case when the target cell could have kept the resources reserved for a longer time. Further, the target cell does not necessarily need to release the reserved resources unless it experiences a high load situation. In view of such drawbacks, certain example embodiments described herein may provide improvements to the NTN time window based on the CHO solution.

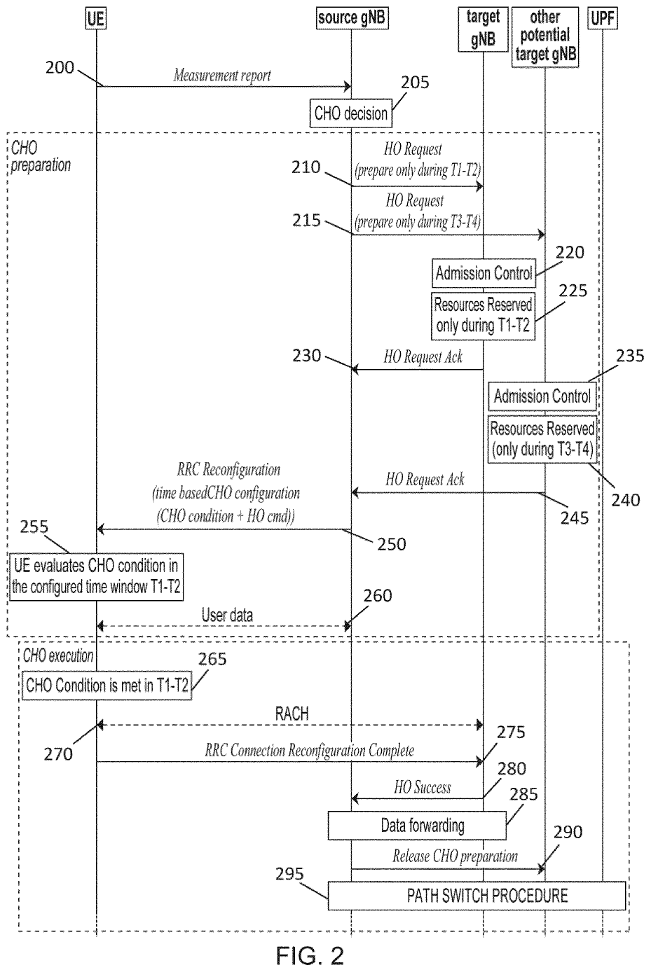

FIG. 2 illustrates an example successful CHO execution scenario in configured time window T1 to T2 (hereinafter “T1-T2”). At 200, the UE may send a measurement report to the source gNB. Based on the measurement report, at 205, the source gNB may make a CHO decision as to whether to initiate CHO. When the source gNB decides that CHO should be initiated, the source gNB may begin CHO preparation by, at 210, sending an HO request to the target gNB. The HO request may include information specifying the target gNB to prepare HO resources (i.e., radio resources) for the UE during the time period of T1-T2. At 215, the source gNB may also send another HO request to other potential target gNB(s), which may include information specifying the other potential target gNB(s) to prepare HO resources during the time period of T3 to T4 (hereinafter, “T3-T4”). At 220, the target gNB may perform admission control, and at 225, the target gNB may reserve resources only during T1-T2.

Once the resources have been reserved by the target gNB, at 230, the target gNB may send a HO request acknowledgment message to the source gNB, acknowledging the HO request. Similarly, at 235, the other potential target gNB may perform admission control, and at 240, may reserve resources only during T3-T4. At 245, the other potential target gNB may send a HO request acknowledgment message to the source gNB, acknowledging the HO request. At 250, the source gNB may indicate to the UE, a time based CHO configuration (CHO condition+HO command) using a RRC reconfiguration message. At 255, the UE may evaluate the CHO condition in the configured time window T1-T2 based on the CHO configuration received from the source gNB, and at 260, the UE and the source gNB may exchange data.

Once the CHO preparation has been completed, CHO execution may begin at 265 where the UE has determined that the CHO condition is met in T1-T2. At 270, random access channel (RACH) procedure may be performed between the UE and the target gNB to enable the UE to access the target gNB, and be synchronized in downlink (DL) and uplink (UL) with the target gNB. At 275, the UE may send a RRC connection reconfiguration complete message to the target gNB confirming the successful completion of an RRC reconfiguration. At 280, the target node may send a message to the source gNB indicating that HO was successful. Further, at 285, the data forwarding between the source gNB and the target gNB may be performed. At 290, the source gNB may send a message to the other potential target gNB to release its CHO preparation. At 295, a path switch procedure may be initiated between the source gNB, target gNB, other potential target gNB, and user plane function (UPF), where the UPF is informed of the HO of the UE from the source gNB to the target gNB or other potential target gNB.

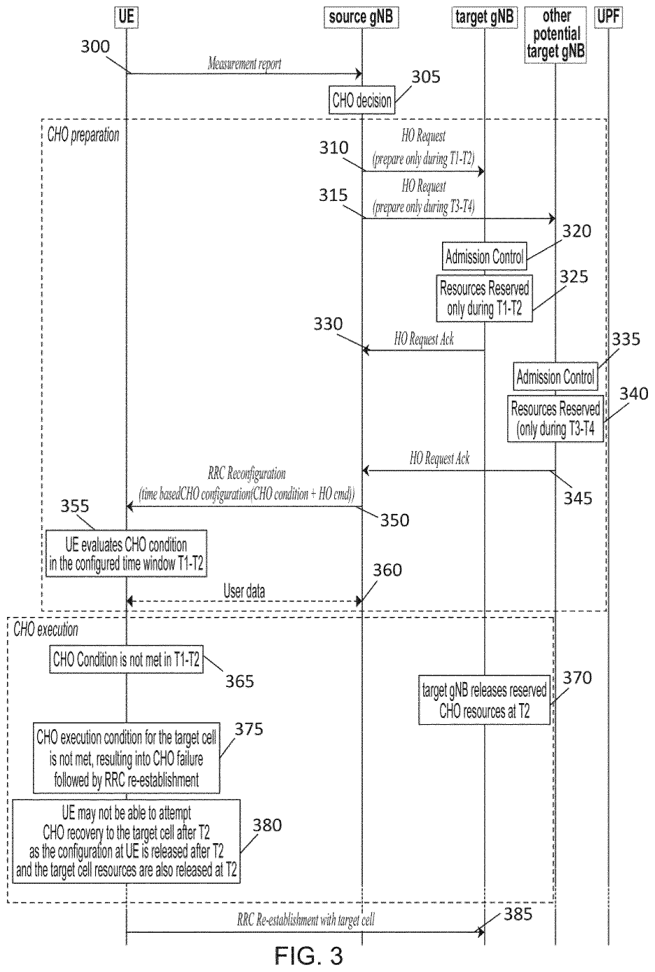

FIG. 3 illustrates an example failed CHO scenario after the configured time window T1-T2. As illustrated in FIG. 3, operations 300 to 365 are similar to operations 200 to 265 in FIG. 2. Thus, a description of operations 300 to 365 is essentially the same as described above with respect to FIG. 2.

At 370, after the UE has determined that the CHO condition is not met in T1-T2, the target gNB releases the reserved CHO resources at T2. At 375, since the CHO execution condition for the target cell is not met, it is determined that CHO has failed resulting in RRC re-establishment. At 380, the UE may not be able to attempt CHO recovery to the target cell after T2 since the configuration at the UE has been released after T2, and the target cell resources have also been released at T2. Thus, at 385, the UE performs RRC re-establishment with the target cell.

As discussed herein, certain example embodiments may address the above-described drawbacks with legacy CHO by enabling CHO recovery when configured by the network. According to certain example embodiments, the CHO recovery may be performed without having the UE to trigger RRC re-establishment resulting from CHO failure when the CHO execution condition is not met during a configured time window such as, for example, T1-T2.

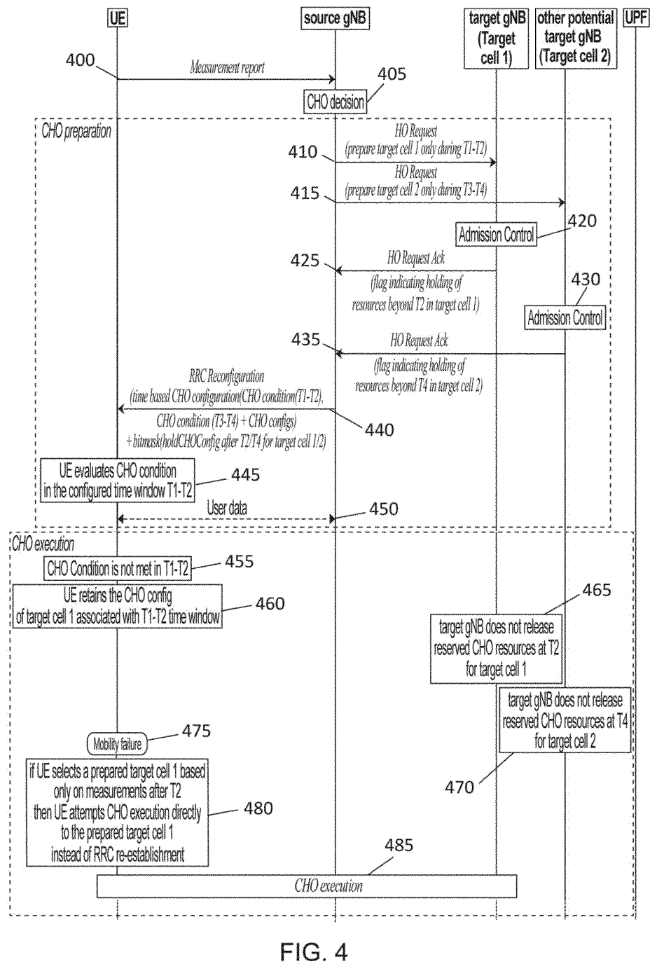

FIG. 4 illustrates an example signal flow diagram, according to certain example embodiments. At 400, the UE may send a measurement report to the source gNB. Based on the measurement report, the source gNB may, at 405, make a CHO decision as to whether to initiate CHO. When the source gNB decides that CHO should be initiated, the source gNB may begin CHO preparation by, at 410, sending an HO request to the target gNB. The HO request may include information specifying the target gNB to prepare HO resources (i.e., radio resources) for the UE during the time period of T1-T2. At 415, the source gNB may also send another HO request to other potential target gNB, which may include information specifying the other potential target gNB to prepare HO resources during the time period of T3-T4. At 420, the target gNB may perform admission control, and at 425, the target gNB may send a HO request acknowledgment message to the source gNB. According to certain example embodiments, the acknowledgment message may include an indication to the source gNB of whether the target gNB will keep the CHO resources for the UE beyond T2. In some example embodiments, the target gNB may keep the CHO resources if load conditions of the target gNB are small enough such that they allow reserving the resources for the UE for a longer time beyond T2. In other example embodiments, the target gNB may also decide to hold the resources beyond T2 based on any other criteria including, for example, quality of service (QOS) parameters.

At 430, the other potential target gNB may perform admission control, and at 435, the other potential target gNB may send a HO request acknowledgment message to the source gNB. In certain example embodiments, the acknowledgment message sent from the other potential target gNB may include an indication to the source gNB of whether the other potential target gNB will keep the CHO resources for the UE beyond T4. Similar to the target gNB, the other potential target gNB may keep the CHO resources if load conditions of the other potential target gNB are small enough such that they allow reserving the resources for the UE for a longer time beyond T4. In other example embodiments, the other potential target gNB may also decide to hold the resources beyond T4 based on other criteria including, for example, QoS parameters.

At 440, the source gNB may, using a RRC reconfiguration message, indicate to the UE whether the UE should release the CHO configuration of a prepared target gNB after T2. For instance, in certain example embodiments, the source gNB may indicate to the UE, using the RRC reconfiguration message, a bitmap that allows the UE to either keep or release the CHO configuration of a prepared target gNB after T2 (for target cell 1 configuration) and T4 (for target cell 2 configuration). As shown at 440, the RRCReconfigurationRequest message may be used by the source gNB to reconfigure (provide configuration) the UE. At 445, the UE may evaluate the CHO condition in the configured time window of T1-T2. Once the evaluation of the CHO condition has been completed, the UE and the source gNB may, at 450, exchange user data.

As illustrated in FIG. 4, once CHO preparation has been completed, CHO execution procedures may begin. For instance, at 455, the UE may determine, based on the evaluation at 445, that the CHO condition has not been met in T1-T2. Thus, at 460, the UE may retain the CHO configuration of the target gNB associated with the T1-T2 time window. Additionally, at 465, the target gNB may not release the reserved CHO resources at T2 for the target gNB. Similarly, at 470, the other potential target gNB may not release reserved CHO resources at T4 for the other potential target gNB.

At 475, the UE may determine mobility failure (i.e., CHO failure). At 480, if the UE selects a prepared target gNB based on measurements after T2, the UE may attempt CHO execution directly to the prepared target gNB instead of performing RRC re-establishment with the target gNB. Thus, at 485, CHO execution may be completed between the UE and source gNB to the target gNB.

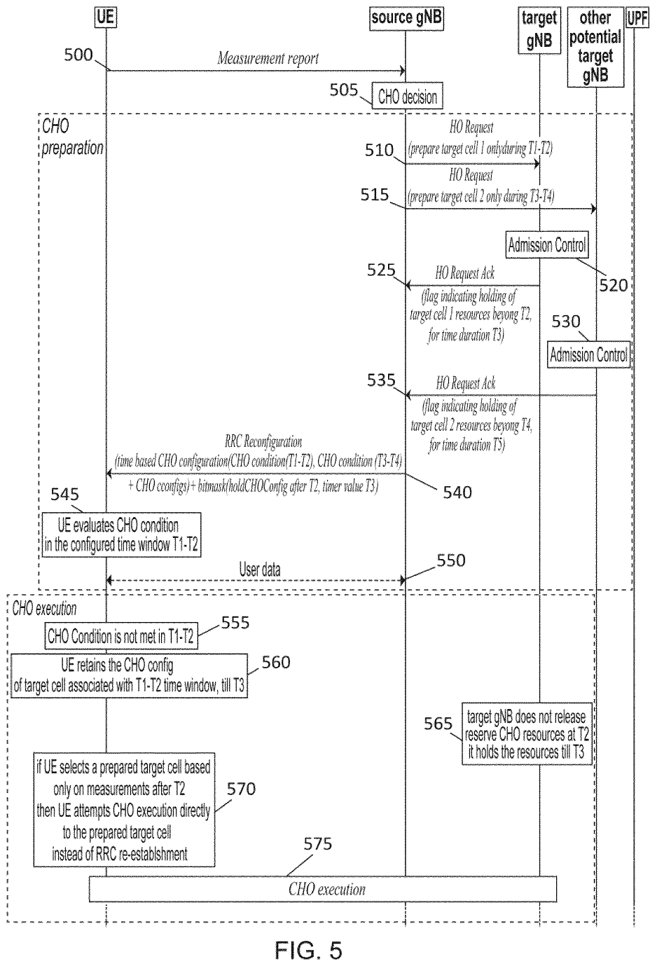

FIG. 5 illustrates another example signal flow diagram, according to certain example embodiments. As illustrated in FIG. 5, operations 500 to 520 are similar to operations 400 to 420 in FIG. 4. Thus, a description of operations 500 to 520 is essentially the same as described above with respect to FIG. 4. At 525, in response to the HO request, the target gNB may indicate, via a HO request acknowledgment message, a time T3 (T2+t) beyond T2 for which the target gNB may hold the CHO resources. At 530, the other potential target gNB may perform admission control. At 535, the other potential target gNB may indicate, via a HO request acknowledgment message, a flag indicating an amount of time that the other potential target gNB may hold CHO resources beyond T4, for a time duration T5.

At 540, the source gNB may, via a RRC reconfiguration message, reconfigure the UE with a bitmap and a timer value for which the UE stores the CHO configuration of a prepared target cell after T2, for a time duration T3. At 545, the UE may evaluate the CHO condition in the configured time window T1-T2. Once the evaluation of the CHO condition has been completed, the UE and the source gNB may, at 550, exchange user data.

As illustrated in FIG. 5, once CHO preparation has been completed, CHO execution procedures may begin. For instance, at 555, the UE may determine, based on the evaluation at 545, that the CHO condition has not been met in T1-T2. Thus, at 560, the UE may retain the CHO configuration of the target gNB associated with the T1-T2 time window until T3. Additionally, at 565, the target gNB may determine not to release the reserved CHO resources at T2, and hold the CHO resources until T3. At 570, if the UE selects a prepared target gNB based on measurements after T2, the UE may attempt CHO execution directly to the prepared target gNB instead of performing RRC re-establishment with the target gNB. Thus, at 575, CHO execution may be completed between the UE and source gNB to the target gNB.

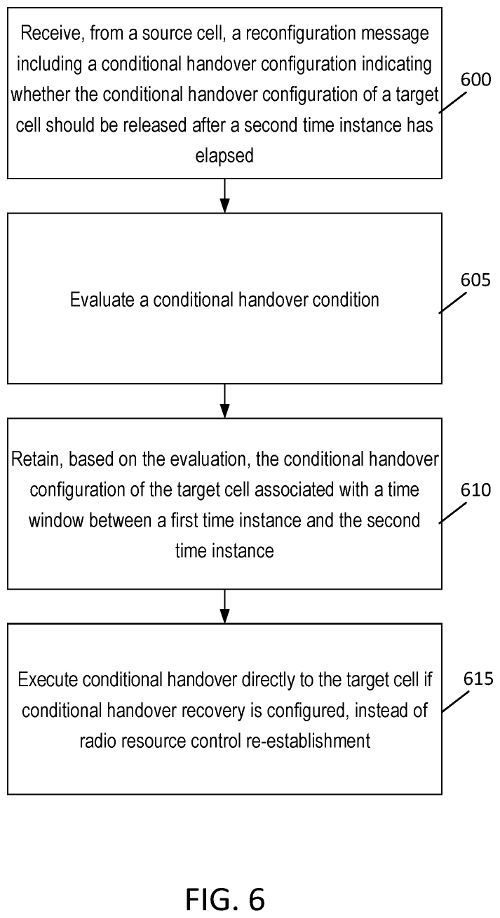

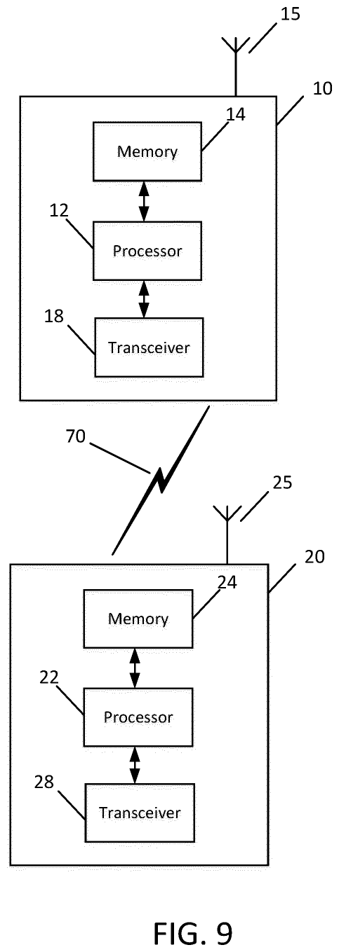

FIG. 6 illustrates an example flow diagram of a method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a UE similar to one of apparatuses 10 or 20 illustrated in FIG. 9.

According to certain example embodiments, the method of FIG. 6 may include, at 600, receiving, from a source cell, a reconfiguration message including a conditional handover configuration indicating whether the conditional handover configuration of a target cell should be released after a second time instance has elapsed. The method may also include, at 605, evaluating a conditional handover condition. The method may further include, at 610, retaining, based on the evaluation, the conditional handover configuration of the target cell associated with a time window between a first time instance and the second time instance. Additionally, the method may include, at 615, executing conditional handover directly to the target cell if conditional handover recovery is configured, instead of radio resource control re-establishment.

According to certain example embodiments, the method may also include selecting the target cell based on measurements after the second time instance has elapsed. According to some example embodiments, the conditional handover may be executed after the conditional handover condition is not satisfied during the time window between the first time instance and the second time instance. According to other example embodiments, the target cell may be selected after the second time instance has elapsed but before a third time instance has elapsed, and the third time instance may occur after the second time instance.

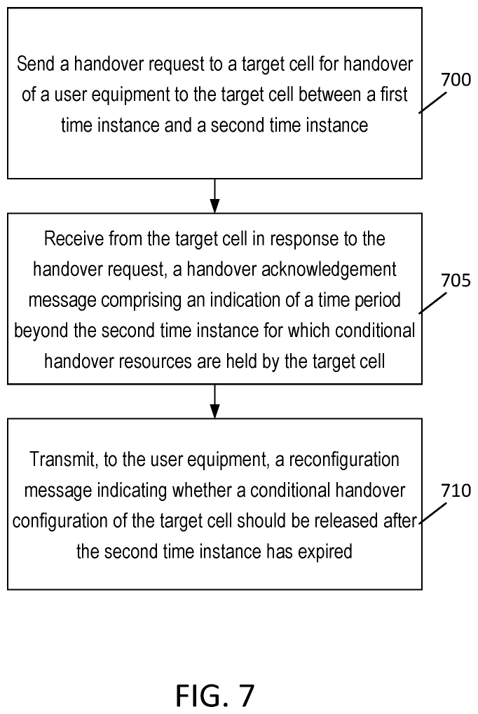

FIG. 7 illustrates an example of a flow diagram of another method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by a network, cell, gNB, a source gNB, or any other device similar to one of apparatuses 10 or 20 illustrated in FIG. 9.

According to certain example embodiments, the method of FIG. 7 may include, at 700, sending a handover request to a target cell for handover of a user equipment to the target cell between a first time instance and a second time instance. The method may also include, at 705, receiving from the target cell in response to the handover request, a handover acknowledgement message including an indication of a time period beyond the second time instance for which conditional handover resources are held by the target cell. The method may further include, at 710, transmitting, to the user equipment, a reconfiguration message indicating whether a conditional handover configuration of the target cell should be released after the second time instance has expired.

According to certain example embodiments, the method may further include reconfiguring the user equipment with a bitmap enabling the user equipment to either keep or release the conditional handover configuration of the target cell after expiration of the second time instance. According to some example embodiments, the time period beyond the second time instance may correspond to a third time instance which is a predetermined amount of time as configured by a network beyond the second time instance. According to other example embodiments, the method may also include reconfiguring the user equipment with a bitmap and a timer value for which the user equipment stores the conditional handover configuration of the target cell after expiration of the second time instance but before expiration of the third time instance. In some example embodiments, the reconfiguration message may include an indication of whether the conditional handover configuration of the target cell should be released after the second time instance has expired.

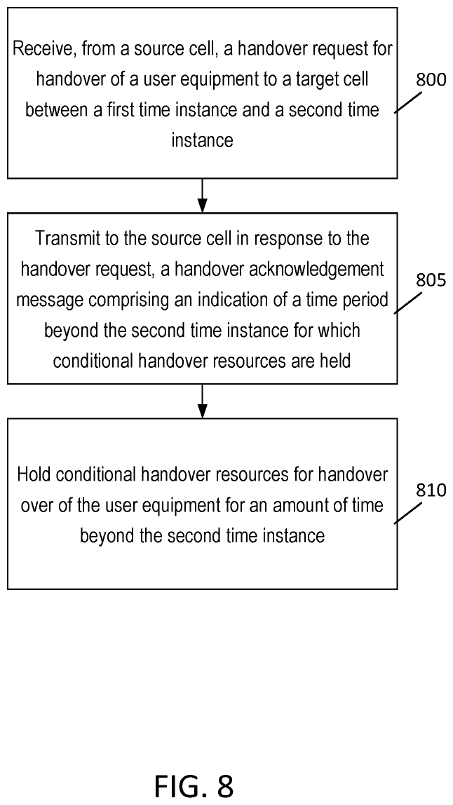

FIG. 8 illustrates an example of a flow diagram of another method, according to certain example embodiments. In an example embodiment, the method of FIG. 8 may be performed by a network entity, or a group of multiple network elements in a 3GPP system, such as LTE or 5G-NR. For instance, in an example embodiment, the method of FIG. 8 may be performed by a network, cell, gNB, a target gNB, or any other device similar to one of apparatuses 10 or 20 illustrated in FIG. 9.

According to certain example embodiments, the method of FIG. 8 may include, at 800, receiving, from a source cell, a handover request for handover of a user equipment to a target cell between a first time instance and a second time instance. The method may also include, at 805, transmitting to the source cell in response to the handover request, a handover acknowledgement message including an indication of a time period beyond the second time instance for which conditional handover resources are held. The method may further include, at 810, holding conditional handover resources for handover over of the user equipment for an amount of time beyond the second time instance.

According to certain example embodiments, the conditional handover resources may be held when the target cell has no resource allocation constraints or a load in the target cell is within an acceptable limit, allowing for reservation of the conditional handover resources for the user equipment for an amount of time beyond the second time instance. According to some example embodiments, the conditional handover resources may be held based on quality of service parameters of the target cell. According to other example embodiments, the method may further include indicating a third time instance that is beyond the second time instance for which the conditional handover resources are held.

FIG. 9 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 9.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 10 may include components or features not shown in FIG. 9.

As illustrated in the example of FIG. 9, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 9, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-8.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-8.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a source cell, a reconfiguration message including a conditional handover configuration indicating whether the conditional handover configuration of a target cell should be released after a second time instance has elapsed. Apparatus 10 may also be controlled by memory 14 and processor 12 to evaluate a conditional handover condition. Apparatus 10 may further be controlled by memory 14 and processor 12 to retain, based on the evaluation, the conditional handover condition of the target cell associated with a time window between a first time instance and the second time instance. In addition, apparatus 10 may be controlled by memory 14 and processor 12 to execute conditional handover directly to the target cell if conditional handover recovery is configured, instead of radio resource control re-establishment.

As illustrated in the example of FIG. 9, apparatus 20 may be a network, core network element, or element in a communications network or associated with such a network, such as a gNB, cell, or NW. It should be noted that one of ordinary skill in the art would understand that apparatus 20 may include components or features not shown in FIG. 9.

As illustrated in the example of FIG. 9, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 9, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-8.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-8.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to send a handover request to a target cell for handover of a user equipment to the target cell between a first time instance and a second time instance. Apparatus 20 may also be controlled by memory 24 and processor 22 to receive from the target cell in response to the handover request, a handover acknowledgement message including an indication of a time period beyond the second time instance for which conditional handover resources are held by the target cell. Apparatus 20 may further be controlled by memory 24 and processor 22 to transmit, the user equipment, a reconfiguration message indicating whether a conditional handover configuration of the target cell should be released after the second time instance has expired.

In other example embodiments, apparatus 20 may be controlled by memory 24 and processor 22 to receive, from a source cell, a handover request for handover of a user equipment to apparatus between a first time instance and a second time instance. Apparatus 20 may also be controlled by memory 24 and processor 22 to transmit to the source cell in response to the handover request, a handover acknowledgement message including an indication of a time period beyond the second time instance for which conditional handover resources are held. Apparatus 20 may further be controlled by memory 24 and processor 22 to hold conditional handover resources for handover over of the user equipment for an amount of time beyond the second time instance.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a source cell, a reconfiguration message including a conditional handover configuration indicating whether the conditional handover configuration of a target cell should be released after a second time instance has elapsed. The apparatus may also include means for evaluating a conditional handover condition. The apparatus may further include means for retaining, based on the evaluation, the conditional handover condition of the target cell associated with a time window between a first time instance and the second time instance. In addition, the apparatus may include means for executing conditional handover directly to the target cell if conditional handover recovery is configured, instead of radio resource control re-establishment.

Certain example embodiments may also be directed to an apparatus that includes means for sending a handover request to a target cell for handover of a user equipment to the target cell between a first time instance and a second time instance. The apparatus may also include means for receiving from the target cell in response to the handover request, a handover acknowledgement message including an indication of a time period beyond the second time instance for which conditional handover resources are held by the target cell. The apparatus may further include means for transmitting, to the user equipment, a reconfiguration message indicating whether a conditional handover configuration of the target cell should be released after the second time instance has expired.

Certain example embodiments may also be directed to an apparatus that includes means for receiving, from a source cell, a handover request for handover of a user equipment to the apparatus between a first time instance and a second time instance. The apparatus may also include means for transmitting to the source cell in response to the handover request, a handover acknowledgement message including an indication of a time period beyond the second time instance for which conditional handover resources are held. The apparatus may further include means for holding conditional handover resources for handover over of the user equipment for an amount of time beyond the second time instance.

Certain example embodiments described herein provide several technical improvements, enhancements, and/or advantages. For instance, in some example embodiments, it may be possible to provide an option of performing CHO recovery instead of RRC re-establishment. For example, if during CHO recovery the UE happens to select a prepared target cell (based purely on measurements, not time window) after the UE's corresponding T2 has elapsed, the UE may perform CHO execution instead of RRC re-establishment. In other example embodiments, it may be possible to allow the target node to reserve the radio resources beyond the time window indicated by the source node when the load in the target node is low.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
BS Base Station
CHO Conditional Handover
eNB Enhanced Node B
E-UTRAN Evolved UTRAN
gNB 5G or Next Generation NodeB
LTE Long Term Evolution
NR New Radio
NTN Non-Terrestrial Network
NW Network
RACH Random Access Channel Procedure
RE Resource element
RRC Radio Resource Control
SSB Synchronization Signal Block
UE User Equipment
UL Uplink
UPF User Plane Function

We claim:

1. A method comprising:
receiving, by a user equipment from a source cell, a reconfiguration message comprising a conditional handover configuration indicating whether the conditional handover configuration of a target cell should be released after a second time instance has elapsed;
evaluating, by the user equipment, a conditional handover condition;
retaining, by the user equipment based on the evaluation, the conditional handover configuration of the target cell associated with a time window between a first time instance and the second time instance; and
executing, by the user equipment, conditional handover directly to the target cell if conditional handover recovery is configured, instead of radio resource control re-establishment.

2. The method according to claim 1, further comprising:
selecting the target cell based on measurements after the second time instance has elapsed.

3. The method according to claim 2,
wherein the conditional handover is executed after the conditional handover condition is not satisfied during the time window between the first time instance and the second time instance.

4. The method according to claim 1,
wherein the target cell is selected after the second time instance has elapsed but before a third time instance has elapsed, and
wherein the third time instance occurs after the second time instance.

5-13. (canceled)

14. An apparatus, comprising:
at least one processor; and
at least one memory comprising computer program code, the at least one memory and the computer program code configured to, with storing instructions that, when executed by the at least one processor, cause the apparatus at least to:
receive, from a source cell, a reconfiguration message comprising a conditional handover configuration indicating whether the conditional handover configuration of a target cell should be released after a second time instance has elapsed;
evaluate a conditional handover condition;
retain, based on the evaluation, the conditional handover configuration of the target cell associated with a time window between a first time instance and the second time instance; and
execute conditional handover directly to the target cell if conditional handover recovery is configured, instead of radio resource control re-establishment.

15. The apparatus according to claim 14, wherein the at least one memory and the computer program code are further configured to, with storing instructions that, when executed by the at least one processor, cause the apparatus at least to:
select the target cell based on measurements after the second time instance has elapsed.

16. The apparatus according to claim 15,
wherein the conditional handover is executed after the conditional handover condition is not satisfied during the time window between the first time instance and the second time instance.

17. The apparatus according to claim 16,
wherein the target cell is selected after the second time instance has elapsed but before a third time instance has elapsed, and
wherein the third time instance occurs after the second time instance.

18. An apparatus, comprising:
at least one processor; and
at least one memory comprising computer program code,
the at least one memory and the computer program code configured to, with storing instructions that, when executed by the at least one processor, cause the apparatus at least to:
send a handover request to a target cell for handover of a user equipment to the target cell between a first time instance and a second time instance;
receive from the target cell in response to the handover request, a handover acknowledgement message comprising an indication of a time period beyond the second time instance for which conditional handover resources are held by the target cell; and
transmit, to the user equipment, a reconfiguration message indicating whether a conditional handover configuration of the target cell should be released after the second time instance has expired.

19. The apparatus according to claim 18, wherein the at least one memory and the computer program code are further configured to, with storing instructions that, when executed by the at least one processor, cause the apparatus at least to:
reconfigure the user equipment with a bitmap enabling the user equipment to either keep or release the conditional handover configuration of the target cell after expiration of the second time instance.

20. The apparatus according to claim 18, wherein the time period beyond the second time instance corresponds to a third time instance which is a predetermined amount of time as configured by a network beyond the second time instance.

21. The apparatus according to claim 20, wherein the at least one memory and the computer program code are further configured to, with storing instructions that, when executed by the at least one processor, cause the apparatus at least to:
reconfigure the user equipment with a bitmap and a timer value for which the user equipment stores the conditional handover configuration of the target cell after expiration of the second time instance but before expiration of the third time instance.

22. The apparatus according to claim 21, wherein the reconfiguration message comprises an indication of whether the conditional handover configuration of the target cell should be released after the second time instance has expired.

23-28. (canceled)
